(19) United States
(12) Patent Application Publication
(10) Pub. No.: US 2011/0157089 A1
(43) Pub. Date: Jun. 30, 2011

(54) METHOD AND APPARATUS FOR MANAGING IMAGE EXPOSURE SETTING IN A TOUCH SCREEN DEVICE

(75) Inventor: Roope Aleksi RAINISTO, Helsinki (FI)

(73) Assignee: NOKIA CORPORATION, Espoo (FI)

(21) Appl. No.: 12/648,144

(22) Filed: Dec. 28, 2009

(51) Int. Cl. G06F 3/042

(52) U.S. Cl. 345/175

(57) ABSTRACT

A method, apparatus, user interface and computer program product for detecting, on a touch screen device displaying an image, a pointing device in proximity to a part of the image, determining an elapsed period of time associated with the proximity of the pointing device to the part, and if the elapsed period of time exceeds a pre-determined time period, activating an exposure control state of the device, determining an exposure level of the part, and adjusting an exposure level of the image in a manner that is inverse to the determined exposure level of the part.

### TECHNICAL FIELD

The aspects of the disclosed embodiments generally relate to touch screen devices, and in particular to adjusting exposure settings of an image displayed on a touch screen device.

### BACKGROUND

Cameras are now found in many devices, including for example, mobile communication devices. The mobile device cameras are gaining many of the features found in dedicated camera counterparts.

One important feature that most camera and other imaging applications allow is photo or image exposure control. While camera devices typically have some type of automatic exposure calculation or settings, the settings are generally applied with an average in mind, which may or may not correspond to the user's desires or preferences. Thus, there needs to be a method to adjust the image, for example, when the sky is too dark or too bright.

In some instances, certain types of control mechanisms will be provided for image exposure control. For example, hard keys or sliders that are hidden behind menu options can be provided. Using this type of mechanism, the user will typically have to scroll the slider slowly, observe the results and readjust if necessary. This process is repeated until the desired exposure level is reached. These types of mechanisms tend to adjust the exposure levels of the entire image and can in some cases require a number of steps to access and utilize the exposure control functions.

The touch screen user interface generally replaces the multitude of buttons and other functions that are available in more traditional style cameras and mobile devices. With these types of devices, the exposure level of a displayed image can be adjusted by touching a portion of the screen. For example, swiping up and down on the screen, when in an image exposure adjusting mode, can be used to adjust the exposure levels. Generally, this can require a swiping motion, observing the results of the change and re-adjusting if necessary. As another example, touching a portion of the image display area and moving the finger across the touchpad can be used to adjust the brightness of the touched areas. This requires contact with the surface of the display and movement on the display. In smaller devices, this contact and movement can be cumbersome or difficult.

Accordingly, it would be desirable to address at least some of the problems identified above.

### SUMMARY

Various aspects of examples of the invention are set out in the claims.

According to a first aspect a method includes detecting, on a touch screen device displaying an image, a pointing device in proximity to a part of the image, determining an elapsed period of time associated with the proximity of the pointing device to the part, and if the elapsed period of time exceeds a pre-determined time period, activating an exposure control state of the device, determining an exposure level of the part, and adjusting an exposure level of the image in a manner that is inverse to the determined exposure level of the part.

According to a second aspect, an apparatus includes at least one processor, the at least one processor being configured to detect, on a touch screen device displaying an image, a pointing device in proximity to a part of the image, determine an elapsed period of time associated with the proximity of the pointing device to the part, and if the elapsed period of time exceeds a pre-determined time period, activating an exposure control state of the device, determine an exposure level of the part, and adjust an exposure level of the image in a manner that is inverse to the determined exposure level of the part.

According to another aspect, a computer program product includes a computer-readable medium bearing computer code embodied therein for use with a computer. The computer program code includes code for detecting, on a touch screen device displaying an image, a pointing device in proximity to a part of the image, code for determining an elapsed period of time associated with the proximity of the pointing device to the part, and if the elapsed period of time exceeds a pre-determined time period, activating an exposure control state of the device, code for determining an exposure level of the part, and code for adjusting an exposure level of the image in a manner that is inverse to the determined exposure level of the part.

### BRIEF DESCRIPTION OF THE DRAWINGS

For a more complete understanding of the example embodiments, reference is now made to the following descriptions taken in connection with the accompanying drawings, in which:

FIG. 1 is a block diagram of an exemplary device incorporating aspects of the disclosed embodiments;

FIGS. 2A-2C are flowcharts of exemplary processes illustrating aspects of the disclosed embodiments;

FIGS. 3A-3E are screenshots illustrating aspects of the disclosed embodiments;

FIGS. 4A and 4B are illustrations of exemplary devices that can be used to practice aspects of the disclosed embodiments;

FIG. 5 illustrates a block diagram of an exemplary system incorporating features that may be used to practice aspects of the disclosed embodiments; and

FIG. 6 is a block diagram illustrating the general architecture of an exemplary system in which the devices of FIGS. 4A and 4B may be used.

### DETAILED DESCRIPTION OF THE DRAWINGS

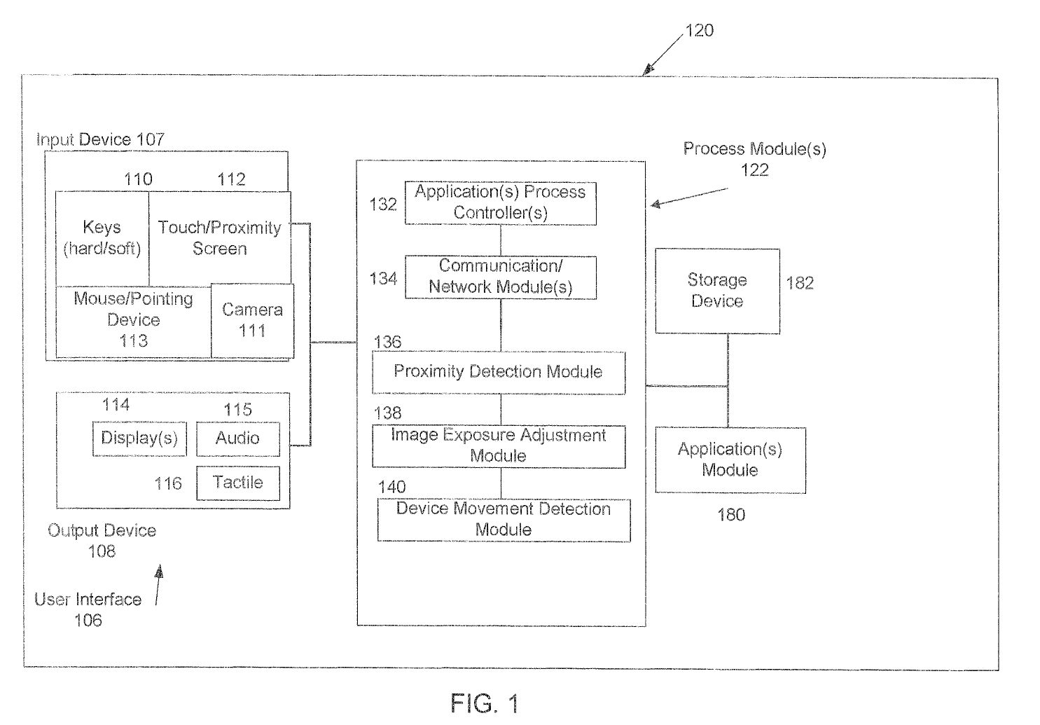

Example embodiments of the present application and its potential advantages are understood by referring to FIGS. 1-6 of the drawings. Although the disclosed embodiments will be described with reference to the embodiments shown in the drawings and described below, it should be understood that these could be embodied in many alternate forms. In addition, any suitable size, shape or type of elements or materials could be used.

The aspects of the disclosed embodiments are generally directed to exposure control and adjustment of an image based upon a detection of a proximity of the user's finger in a substantially fixed position over a part of the image, also referred to herein as “hovering.” The terms “proximate”, “proximity” and “hovering” are generally intended to mean near, but not in direct contact with a surface of a touch screen display. Very often, when a user is viewing an image, such as a photograph, the will have in mind what part of the image or photo they would like to adjust the exposure settings for, and which part of the image is too dark or too light. The aspects of the disclosed embodiments allow for adjusting the exposure settings by hovering the pointing device, such as the finger, near the part of the image that is too light or too dark. Although the aspects of the disclosed embodiments will generally be described with respect to images such as photographs, in alternate embodiments, it will be understood that the image(s) can include any suitable image that is presented on a touch screen display for which exposure and lighting levels can be adjusted.

In one embodiment, the user hovers their finger, for example, over a part of the image on the touch screen display. After a brief timeout, or other time period of hovering over a substantially fixed position relative to the image, the position of the finger is related to the area of the image and the exposure control function of the device is activated. If the user is hovering their finger over a dark area of the image, the exposure level of the image is adjusted to be lighter. If the user is hovering their finger over a light part of the image, the exposure level of the image is adjusted to be darker. In one embodiment, the amount of exposure level change, whether lighter or darker, is pre-determined.

FIG. 1 illustrates one embodiment of an exemplary communication device or apparatus 120 that can be used to practice aspects of the disclosed embodiments. The communication device 120 of FIG. 1 generally includes a user interface 106, one or more process module(s) 122, one or more application module(s) 180, and one or more storage device(s) 182. In alternate embodiments, the device 120 can include other suitable systems, devices and components that allow the exposure and light levels of an image be displayed on a touch screen display to be adjusted by hovering a finger over a part of the image. The components described herein are merely exemplary and are not intended to encompass all components that can be included in, or used in conjunction with the device 120. The components described with respect to the device 120 will also include one or more processors or computer program products to execute the processes, methods, sequences, algorithms and instructions described herein.

The user interface 106 of the device 120 generally includes input device(s) 107 and output device(s) 108. The input device(s) 107 are generally configured to allow for the input of data, instructions, information gestures and commands to the device 120. The input device 107 can include one or a combination of input devices such as, for example, but not limited to, keys or keypad 110, a touch sensitive area or touch screen 112 or proximity screen, and a mouse or pointing device 113. In one embodiment, the keypad 110 can be a soft key or other such adaptive or dynamic device of a touch screen 112. The input device 107 can also be configured to receive input commands remotely or from another device that is not local to the device 120. The input device 107 can also include camera device(s) 111 or other such image capturing system(s).

The output device(s) 108 is generally configured to allow information and data to be presented to the user and can include one or more devices such as, for example, a display 114, audio device 115 and/or tactile output device 116. In one embodiment, the output device 108 can also be configured to transmit information to another device, which can be remote from the device 120. While the input device 107 and output device 108 are shown as separate devices, in one embodiment, the input device 107 and output device 108 can comprise a single device, such as for example a touch screen device, and be part of and form, the user interface 106. For example, in one embodiment where the user interface 106 includes a touch screen device 112, the touch screen 112 can also serve as an output device as part of the display 114, providing functionality and displaying information, such as keypad or keypad elements and/or character outputs in the touch sensitive area of the display 114. While certain devices are shown in FIG. 1, the scope of the disclosed embodiments is not limited by any one or more of these devices, and alternate embodiments can include or exclude one or more devices shown.

The process module 122 is generally configured to execute the processes and methods of the aspects of the disclosed embodiments. The process module 122 can include hardware, software and application logic, or a combination thereof. As described herein, the process module 122 is generally configured to detect that a pointing device is in a substantially fixed position proximate to the touch screen display for a pre-determined period of time and define an area of the image that corresponds to the substantially fixed position of the pointing device. The process module 122 is configured to activate an exposure and lighting control function of the device, and adjust the exposure level or values of the image, based on the exposure level of the designated area of an image.

In one embodiment, the process module 122 can include a proximity detection module 136. The proximity detection module 122 is generally configured to detect the nearness, or proximity of a pointing device to the touch screen display. In one embodiment, this comprises determining that the pointing device is near to or close to the touch sensitive surface of the touch sensitive display as is generally understood with respect to such touch or proximity type devices. The proximity detection module 122 can also be configured to determine if the pointing device is in a substantially fixed position relative to the touch screen display. In one embodiment, this comprises determining a position of the pointing device relative to the touch sensitive surface of the touch sensitive display and determining that the pointing device remains with certain pre-defined boundaries relative to the position. For example, it will be understood that it is not always possible to hold a pointing device, such as a finger, in a steady position. Thus, some limited movement will be permissible with respect to determining that the pointing device is being held in a substantially fixed position. For example, movement of the pointing device a distance in the range of approximately 1-5 millimeters from a defined origin could be permissible for determining that the pointing device is being held in a substantially fixed position over the image presented on the touch screen display. In alternate embodiments, the movement parameters or variations can be within any desired limits or tolerances.

The proximity detection module 136 can also be configured to determine an elapsed time that the pointing device is in proximity to the touch sensitive surface of the touch sensitive display and in the substantially fixed position. This can include setting a timer when both parameters are met and monitoring the elapsed time. Alternatively, in one embodiment, one timer can be set when the pointing device is in the proximity of the touch sensitive surface and another timer set when the pointing device is determined to be in the substantially fixed position. The elapsed time of both timers can be compared to preset or predetermined values. When the elapsed time expires, or the predetermined values satisfied, the exposure adjustment function of the device 120 is activated.

The proximity detection module 136 can also be configured to define or acquire the selected image area. Once the pointing device is held in the substantially fixed position for a certain period of time, the substantially fixed position can be correlated to a portion of the image being displayed. This portion of the image is then identified or otherwise designated as the selected image area. Any suitable method can be used to identify and select the image area. In embodiment, a size of the selected image area can be predetermined. For example, the size or area of the selected image area can be in the range of 1 to 5 centimeters. In alternate embodiments, the size of the select image area can be any suitable size. Also, the shape of the selected image area can be any suitable shape, including for example, a circular area, a square, rectangle or ellipse.

The image exposure adjustment module 138 is generally configured to determine the exposure and light levels or values of the selected image area. In one embodiment, it is determined whether the selected image area is dark or light. Dark and light can be determined in multiple ways. For example, many camera devices use middle gray, also referred to as 18% gray, as a determining level. Generally, middle or 18% gray represents a tone that us perceptually about halfway between black and white on an exposure or light value scale. In alternate embodiments, any suitable color model and value scale can be used. In one embodiment the image exposure adjustment module 138 can comprise or be coupled to a suitable luminance or reflectivity meter that provides the corresponding exposure and light levels for determining degrees of light and dark.

In one embodiment, an average exposure value for the selected image area is determined. In the event that there are variations in exposure levels within the selected image area, using an average value will generally ensure a consistent exposure level adjustment. For example, if within the selected image there is a small dark area while the rest of the area is light, using an average exposure level value will prevent the small dark area being the sole factor used to adjust the image exposure as is. In alternate embodiments, any suitable means of determining the exposure and light levels for the selected image area can be used.

Based on the determined exposure value for the selected image area, the exposure level for the image can be adjusted. In one embodiment, if the exposure value for the selected image area is determined to be dark relative to the 18% gray level, the exposure value of the image will be adjusted to make the image lighter. In one embodiment, the adjustment is a smooth adjustment, such as for example, +0.5 per one second over hovering. In alternate embodiments, the adjustment steps can be any suitable increments. Generally, the more steps that can be supported for the exposure adjustment, the smaller and quicker each adjustment increment can be. If the exposure value of the selected image area is determined to be light, the exposure value of the image will be adjusted to make the image darker. Thus, by hovering a finger over a portion of an image, the exposure values of the image can be adjusted inversely to the exposure value of the portion of the image. Although the aspects of the disclosed embodiments are generally described with respect to detection of a single hovering point for image exposure level adjustment, the aspects of the disclosed embodiments are not so limited and can include the use of more than one hovering point. For example, in one embodiment, two or more hovering points can be detected and used for image exposure adjustment. In this embodiment, an image exposure adjustment algorithm can be used for adjusting the exposure. This can include for example, taking an average of the two or more hovering points and adjusting the exposure level of the image based on the average level. In alternate embodiments, any suitable algorithm can be used to determine the image exposure level adjustment.

It may also be desirable to be able to reset the exposure values of the image to a default setting or a previous exposure setting. In one embodiment, a “shaking” of the device 120 can be used to reset the exposure value settings. The device movement detection module 140 can be configured to detect a “shaking” movement of the device, such as a rapid side-to-side or up-and-down motion. Differences in the rate of the shaking and/or the direction of the movement can be used to determine how the exposure values are set or re-set. For example, a side-to-side movement could indicate a command to reset the exposure values to a default level. An up-and-down movement could indicate restoring the exposure values to the previous exposure level (prior to any adjustment). In alternate embodiments, any suitable combination of rate and motion can be used.

The application process controller 132 shown in FIG. 1 is generally configured to interface with the application module 180 and execute applications processes with respect to the other components and modules of the device 120. In one embodiment the application module 180 is configured to interface with applications that are stored either locally to or remote from the device 120. The application module 180 can include any one of a variety of applications that may be installed, configured or accessible by the device 120, such as for example, contact applications and databases, office and business applications, media player applications, multimedia applications, web browsers, global positioning applications, navigation and position systems, and map applications. The application module 180 can also include a voice recognition system that includes a text-to-speech module that allows the user to receive and input voice commands, prompts and instructions, through a suitable audio input device. In alternate embodiments, the application module 180 can include any suitable application that can be used by or utilized in the processes described herein.

The communication module 134 shown in FIG. 1 is generally configured to allow the device 120 to receive and send communications and data including for example, telephone calls, text messages, push to talk cellular service, location and position data, navigation information, chat messages, multimedia messages, video and email. The communications module 134 is also configured to receive information, data and communications from other devices and systems or networks, such as for example, the Internet. In one embodiment, the communications module 134 is configured to interface with, and establish communications connections with other services and applications using the Internet.

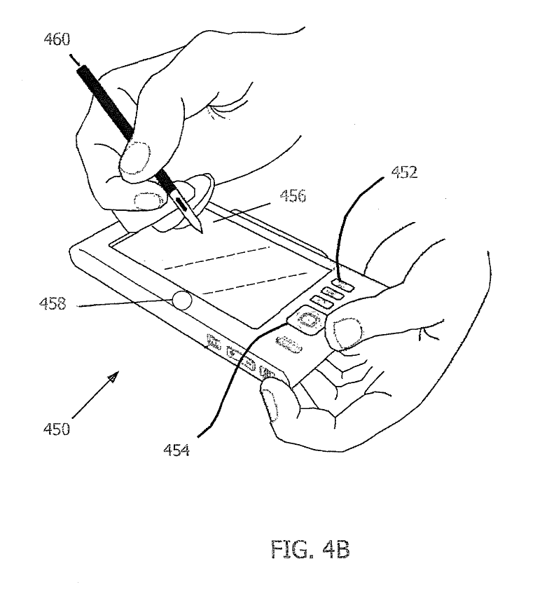

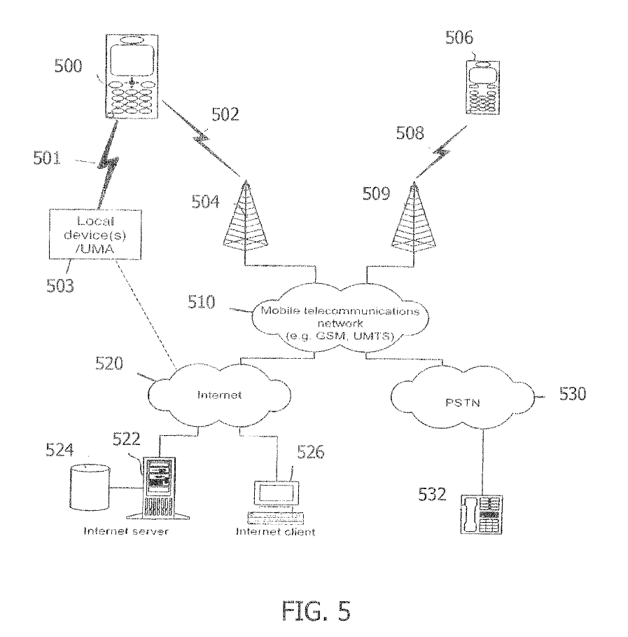

Some examples of devices on which aspects of the disclosed embodiments can be practiced are illustrated in FIGS. 4A-4B. The devices are merely exemplary and are not intended to encompass all possible devices or all aspects of devices on which the disclosed embodiments can be practiced. The aspects of the disclosed embodiments can rely on very basic capabilities of devices and their user interface.

FIG. 4A illustrates one example of a device 400 that can be used to practice aspects of the disclosed embodiments. As shown in FIG. 4A, in one embodiment, the device 400 has a display area 402 and an input area 404. The input area 404 is generally in the form of a keypad 406. In one embodiment the input area 404 is touch sensitive. As noted herein, in one embodiment, the display area 402 can also have touch sensitive characteristics. Although the display 402 of FIG. 4A is shown being integral to the device 400, in alternate embodiments, the display 402 may be a peripheral display connected or coupled to the device 400.

In one embodiment, the keypad 406, in the form of soft keys, may include any suitable user input functions such as, for example, a multi-function/scroll key 408, soft keys 410, 412, call key 414, end key 416 and alphanumeric keys 418.

Another example of a device 450 that can be used to practice aspects of the disclosed embodiments is shown in FIG. 4B. In this embodiment, the device 450 can include a keypad 452, cursor control 454, a touch screen display 456, and a pointing device 460 for use on the touch screen display 456. In one embodiment, the touch screen display 456 can include the QWERTY keypad as discussed herein. The touch screen area 456 of the device 450 can also present secondary functions, other than a keypad, using changing graphics.

As shown in FIG. 4B, in one embodiment, a pointing device 460, such as for example, a stylus, pen or simply the user's finger, may be used with the touch sensitive display 456. In alternate embodiments any suitable pointing device may be used. In other alternate embodiments, the display may be any suitable display, such as for example a flat display 456 that is typically made of a liquid crystal display (LCD) with optional back lighting, such as a thin film transistor (TFT) matrix capable of displaying color images.

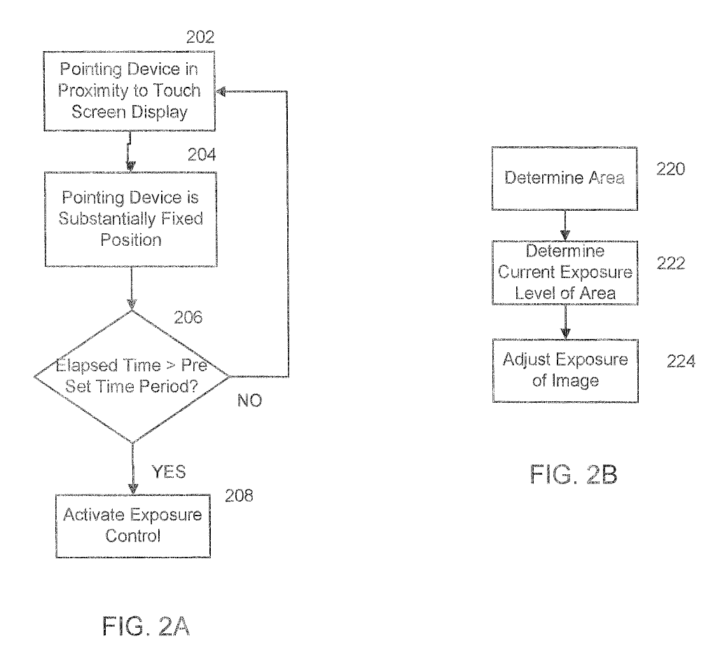

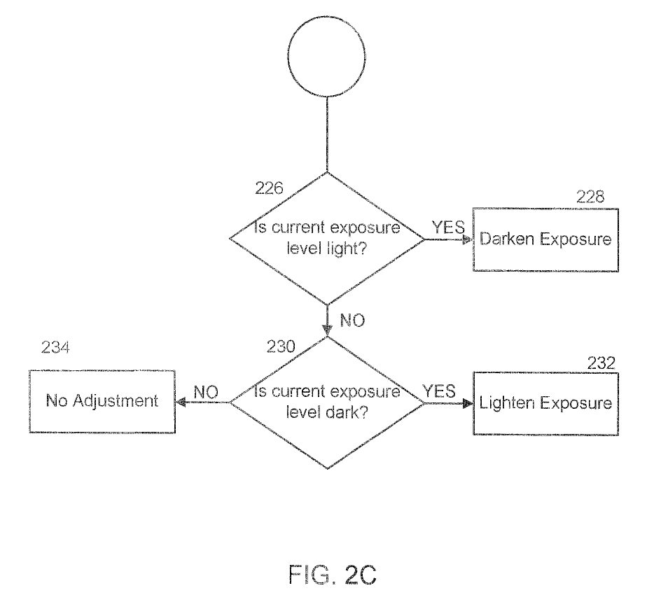

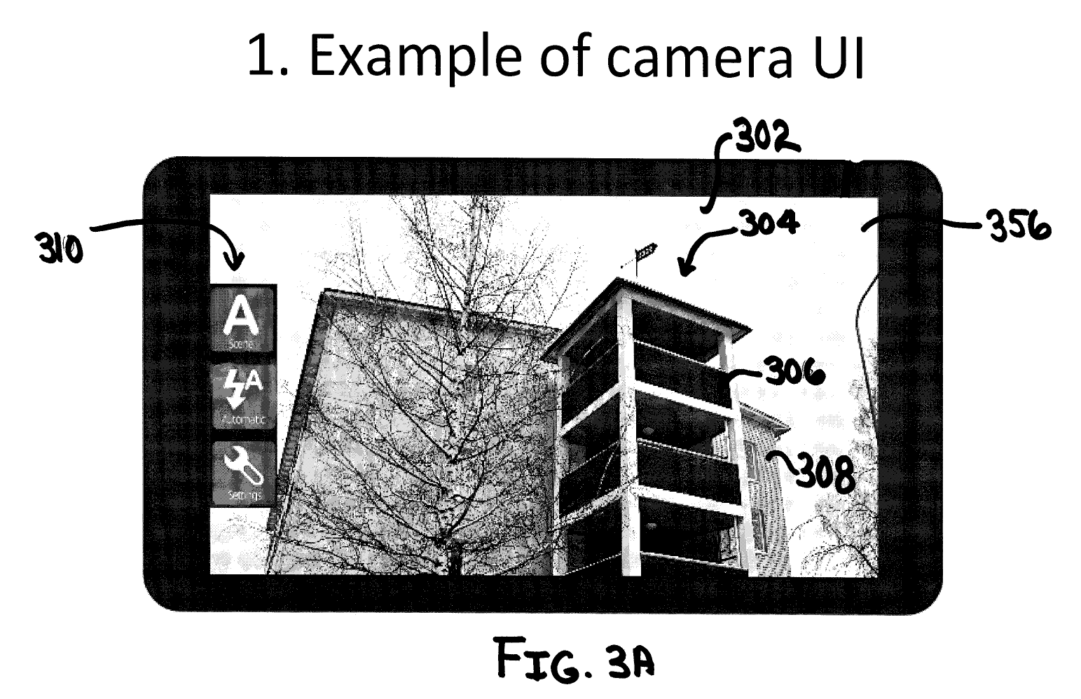

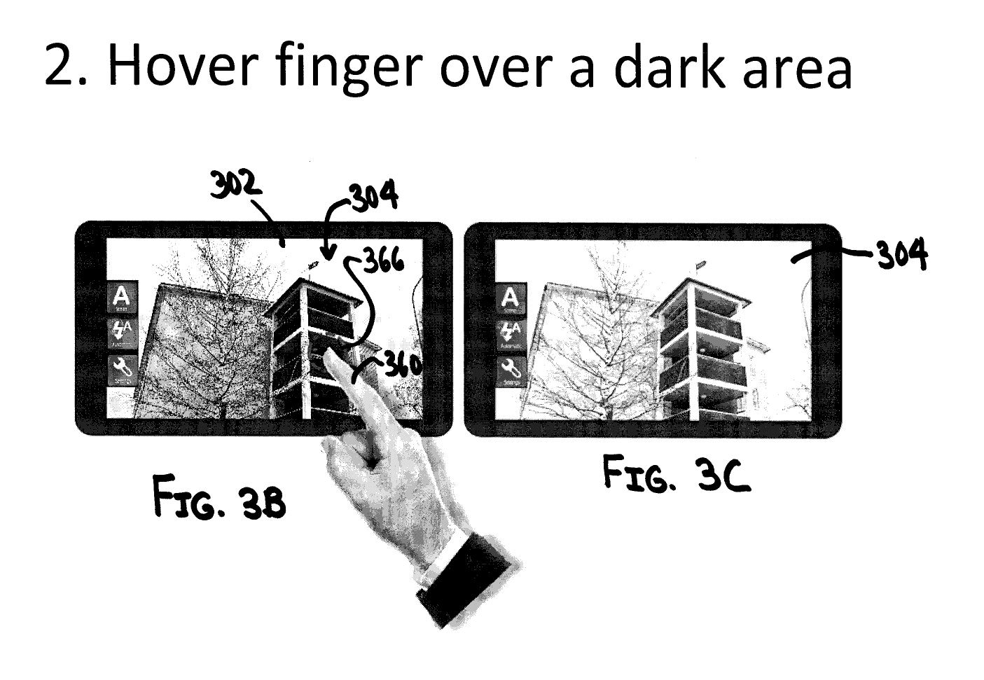

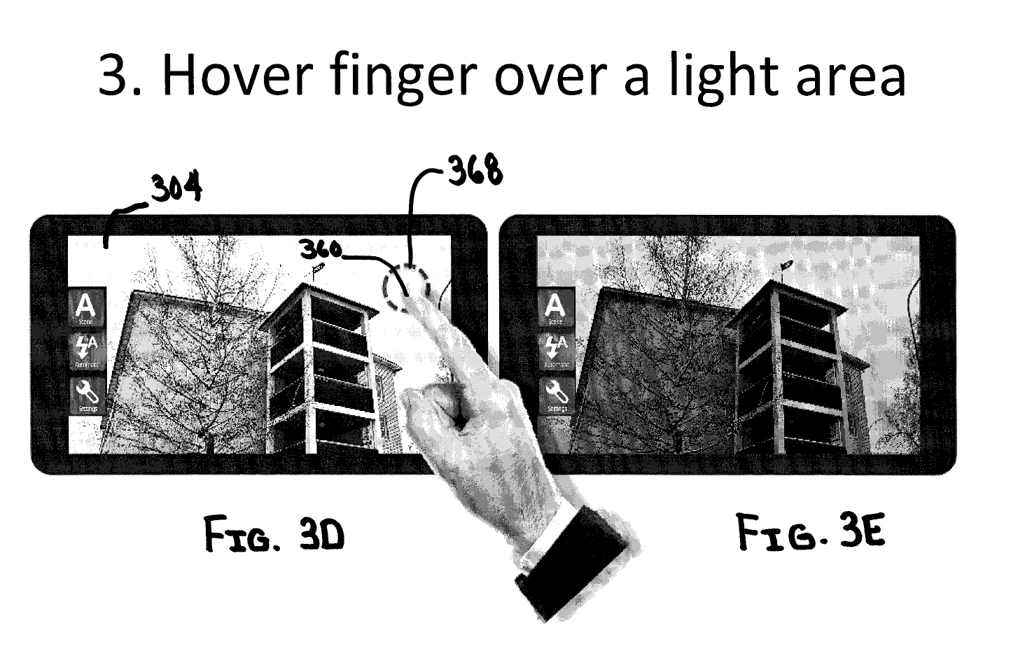

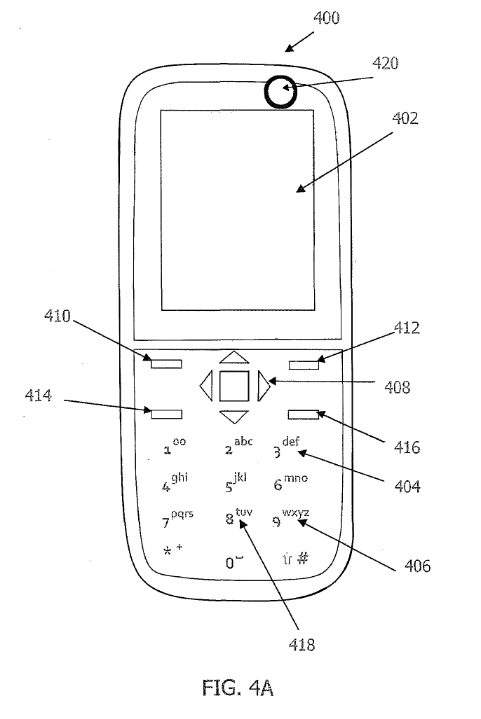

FIG. 2A illustrates an exemplary process incorporating aspects of the disclosed embodiments. A pointing device 460 is detected 202 in proximity to a surface of touch screen display 456 on which an image is displayed. One example of such an image is shown in FIG. 3A, where image 304 is presented on the screen 302 of touch screen display 356. The image 304 could be an image currently captured by the camera 458 of the device 456, or an image retrieved from a suitable storage facility. A determination is made as to whether the pointing device 460 is in a fixed position 204 relative to the image 304 on the touch screen display 456. If the pointing device 460 is in a substantially fixed position, a determination 206 is made as to whether a period of time that the pointing device 460 has been in the substantially fixed position in proximity to the touch screen display 456 exceeds a pre-set or pre-determined time period. If not, the process loops back until a determination is made that the period of time that the pointing device 460 is in proximity to the touch screen display 456 in the fixed position exceeds the pre-determined time period. Once it is determined that the pointing device 460 has been in proximity to the touch screen display for at least the pre-determined time period, the image exposure control function is activated 208.

In one embodiment, referring to FIG. 2B, the image area corresponding to the position of the pointing device 460 in proximity to the image 304 is determined 220. This can include for example, selecting or fixing a region on the image 304 that is near to, or close to the general position of the portion of the pointing device 460 that is in proximity to the image 304. One example of such a region is shown in FIG. 3D, where the region 368 is fixed as the selected image area. Once the image area is determined and selected, an exposure level of the selected image area is determined 222. Determining the exposure level of the selected image area can involve determining whether the selected image area is light or dark, relative to the middle grey or 18% grey value. Once the exposure level of the selected image area is determined 222, the exposure level of the image can be adjusted 224 accordingly.

In one embodiment, in order to adjust the exposure level of the selected image area, referring to FIG. 2C, a determination 226 is made as to whether the current exposure level of the selected image area is “light.” If yes, then the exposure level of the image is darkened 228. If the exposure level of the image is not light, it is determined 230 whether the current exposure level of the selected image area is “dark”. If yes, then the exposure level of the image is lightened 232. If the current exposure level is determined not to be dark or light, then, in one embodiment, no adjustment 234 is made.

FIG. 3A illustrates one example of an image user interface 302 with a touch screen display 356 including aspects of the disclosed embodiments. Image 304 is presented on the user interface 302. The image 304 includes dark and light areas, for example dark area 306 and light area 308. As with any typical image, the image 304 can include a combination of light and dark areas. Also shown in this exemplary user interface, or screen 302 is a tool bar 310 that can include various controls and functions related to image control, for example.

Referring to FIG. 3B, a pointing device 360, which in this example is the user's finger, is hovered over a dark area 366 of the image 304. The image 304 is then adjusted to be lighter, as is illustrated in FIG. 3C.

FIG. 3D illustrates the situation where the user's finger 360 is hovered over area 360, that has an exposure level that is lighter than other areas of the image 304. In this example, the entirety of the image 304 is darkened, as is shown in FIG. 3E. As shown in FIG. 3D, in this embodiment, the portion of the image area that defined as the “selected image area” has a pre-defined size represented by the circle 368. The size and/or shape of the area 368 is generally sufficient to determine a general exposure level of the area 360 as is described herein.

The terms “select” and “touch” are generally described herein with respect to a touch screen-display. However, in alternate embodiments, the terms are intended to encompass the required user action with respect to other input devices. For example, with respect to a proximity screen device, it is not necessary for the user to make direct contact in order to select an object or other information. Thus, the above noted terms are intended to include that a user only needs to be within the proximity of the device to carry out the desired function.

Similarly, the scope of the intended devices is not limited to single touch or contact devices. Multi-touch devices, where contact by one or more fingers or other pointing devices can navigate on and about the screen, are also intended to be encompassed by the disclosed embodiments. Non-touch devices are also intended to be encompassed by the disclosed embodiments. Non-touch devices include, but are not limited to, devices without touch or proximity screens, where navigation on the display and menus of the various applications is performed through, for example, keys 110 of the system or through voice commands via voice recognition features of the system.

In one embodiment, referring to FIG. 4A, the device 400 can include an image capturing device such as a camera 420 (similarly device 456 can include camera 458) as a further input device. The device 400 may also include other suitable features such as, for example a loud speaker, tactile feedback devices or connectivity port. The mobile communications device may have a processor or other suitable computer program product connected or coupled to the display for processing user inputs and displaying information on the display 402 or touch sensitive area 456 of device 450. A computer readable storage device, such as a memory may be connected to the processor for storing any suitable information, data, settings and/or applications associated with each of the mobile communications devices 400 and 450.

Although the above embodiments are described as being implemented on and with a mobile communication device, it will be understood that the disclosed embodiments can be practiced on any suitable device incorporating a processor, memory and supporting software or hardware. For example, the disclosed embodiments can be implemented on various types of music, gaming and multimedia devices. In one embodiment, the device 120 of FIG. 1 may be for example, a personal digital assistant (PDA) style device 450 as illustrated in FIG. 4B. In still other alternate embodiments, the device may be a personal computer, a tablet computer, touch pad device, Internet tablet, a laptop or desktop computer, a mobile terminal, a cellular/mobile phone, a multimedia device, a personal communicator, a television set top box, a digital video/versatile disk (DVD) or high definition player or any other suitable device capable of containing for example a display and supported electronics such as a processor(s) and memory(s). In one embodiment, these devices will be Internet enabled and include GPS and map capabilities and functions.

In the embodiment where the device 400 comprises a mobile communications device, the device can be adapted for communication in a telecommunication system, such as that shown in FIG. 5. In such a system, various telecommunications services such as cellular voice calls, worldwide web/wireless application protocol (www/wap) browsing, cellular video calls, data calls, facsimile transmissions, data transmissions, music transmissions, multimedia transmissions, still image transmission, video transmissions, electronic message transmissions and electronic commerce may be performed between the mobile terminal 500 and other devices, such as another mobile terminal 506, a line telephone 532, a personal computer (Internet client) 526 and/or an interne server 522.

It is to be noted that for different embodiments of the mobile device or terminal 500, and in different situations, some of the telecommunications services indicated above may or may not be available. The aspects of the disclosed embodiments are not limited to any particular set of services or communication, protocol or language in this respect.

The mobile terminals 500, 506 may be connected to a mobile telecommunications network 510 through radio frequency (RF) links 502, 508 via base stations 504, 509. The mobile telecommunications network 510 may be in compliance with any commercially available mobile telecommunications standard such as for example the global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 510 may be operatively connected to a wide-area network 520, which may be the Internet or a part thereof. An Internet server 522 has data storage 524 and is connected to the wide area network 520. The server 522 may host a worldwide web/wireless application protocol server capable of serving worldwide web/wireless application protocol content to the mobile terminal 500. The mobile terminal 500 can also be coupled to the Internet 520. In one embodiment, the mobile terminal 500 can be coupled to the Internet 520 via a wired or wireless link, such as a Universal Serial Bus (USB) or Bluetooth™ connection, for example.

A public switched telephone network (PSTN) 530 may be connected to the mobile telecommunications network 510 in a familiar manner. Various telephone terminals, including the stationary telephone 532, may be connected to the public switched telephone network 530.

The mobile terminal 500 is also capable of communicating locally via a local link 501 to one or more local devices 503. The local links 501 may be any suitable type of link or piconet with a limited range, such as for example Bluetooth™, a USB link, a wireless Universal Serial Bus (WUSB) link, an IEEE 802.11 wireless local area network (WLAN) link, an RS-232 serial link, etc. The local devices 503 can, for example, be various sensors that can communicate measurement values or other signals to the mobile terminal 500 over the local link 501. The above examples are not intended to be limiting and any suitable type of link or short range communication protocol may be utilized. The local devices 503 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 500 may thus have multi-radio capability for connecting wirelessly using mobile communications network 510, wireless local area network or both. Communication with the mobile telecommunications network 510 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the communication module 134 of FIG. 1 is configured to interact with, and communicate with, the system described with respect to FIG. 5.

Without in any way limiting the scope, interpretation, or application of the claims appearing below, a technical effect of the one or more example embodiments disclosed herein is exposure or lighting effect control of an image based on detecting a hovering of the user's finger over a portion of an image presented on a touch screen display.

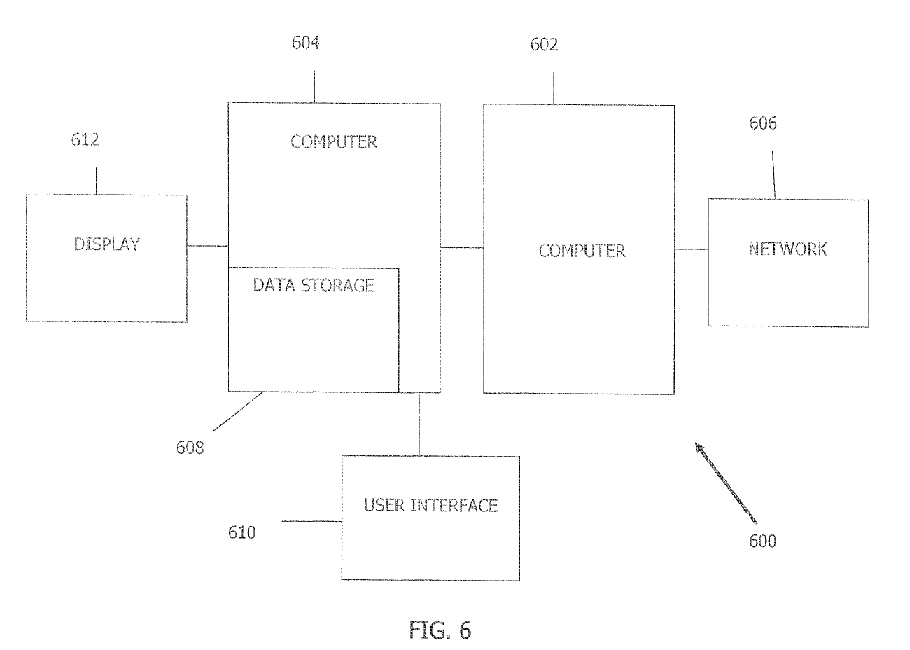

The aspects of the disclosed embodiments may be implemented in software, hardware, application logic or a combination of software hardware and application logic. The software, application logic and/or hardware may reside on one or more computers as shown in FIG. 6. If desired, part of the software, application logic and/or hardware may reside on one computer 602, while part of the software, application logic and/or hardware may reside on another computer 604. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted in FIG. 6. A computer-readable medium may comprise a computer readable storage medium that may be any media or means that can contain or store the instructions for use by or in connection with an instruction execution system, apparatus or device, such as a computer.

The disclosed embodiments may also include software and computer programs incorporating the process steps and instructions described above. In one embodiment, the programs incorporating the process steps described herein can be stored on or in a computer program product and executed in one or more computers. FIG. 6 is a block diagram of one embodiment of a typical apparatus 600 incorporating features that may be used to practice aspects of the invention. The apparatus 600 can include computer readable program code means embodied or stored on a computer readable storage medium for carrying out and executing the process steps described herein. In one embodiment the computer readable program code is stored in a memory(s) of the device. In alternate embodiments the computer readable program code can be stored in memory or other storage medium that is external to, or remote from, the apparatus 600. The memory can be direct coupled or wireless coupled to the apparatus 600. As shown, a computer system 602 may be linked to another computer system 604, such that the computers 602 and 604 are capable of sending information to each other and receiving information from each other. In one embodiment, computer system 602 could include a server computer adapted to communicate with a network 606. Alternatively, where only one computer system is used, such as computer 604, computer 604 will be configured to communicate with and interact with the network 606. Computer systems 602 and 604 can be linked together in any conventional manner including, for example, a modem, wireless, hard wire connection, or fiber optic link. Generally, information can be made available to both computer systems 602 and 604 using a communication protocol typically sent over a communication channel or other suitable connection or line, communication channel or link. In one embodiment, the communication channel comprises a suitable broad-band communication channel. Computers 602 and 604 are generally adapted to utilize program storage devices embodying machine-readable program source code, which is configured to cause the computers 602 and 604 to perform the method steps and processes disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media, such as a diskette, disk, memory stick or computer hard drive, which is readable and executable by a computer. In other alternate embodiments, the program storage devices could include optical disks, read-only-memory (“ROM”) floppy disks and semiconductor materials and chips.

Computer systems 602 and 604 may also include a microprocessor(s) for executing stored programs. Computer 602 may include a data storage device 608 on its program storage device for the storage of information and data. The computer program or software incorporating the processes and method steps incorporating aspects of the disclosed embodiments may be stored in one or more computers 602 and 604 on an otherwise conventional program storage device. In one embodiment, computers 602 and 604 may include a user interface 610, and/or a display interface 612 from which aspects of the invention can be accessed. The user interface 610 and the display interface 612, which in one embodiment can comprise a single interface, can be adapted to allow the input of queries and commands to the system, as well as present the results of the commands and queries, as described with reference to FIG. 1, for example.

The aspects of the disclosed embodiments provide for exposure and lighting control of an image on a touch screen display. A pointing device, such as a finger, is hovered over a portion of the image. A determination as to an exposure level of the portion of the image is determined. In one embodiment, if the exposure level of the portion is dark, the exposure or lighting level of the image is lightened. If the exposure level of the portion is light, then the exposure or lighting level of the image is darkened.

It is noted that the embodiments described herein can be used individually or in any combination thereof. If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the invention as defined in the appended claims.

What is claimed is:

1. A method comprising:
detecting, on a touch screen device displaying an image, a pointing device in proximity to a part of the image;
determining an elapsed period of time associated with the proximity of the pointing device to the part, and if the elapsed period of time exceeds a pre-determined time period, activating an exposure control state of the device;
determining an exposure level of the part; and
adjusting an exposure level of the image in a manner that is inverse to the determined exposure level of the part.

2. The method of claim 1 wherein the pointing device is in a substantially fixed position.

3. The method of claim 1 wherein determining the exposure level of the part comprises:
determining a brightness value for the part;
determining if the brightness value of the part exceeds a pre-determined brightness value, wherein if the brightness value exceeds the pre-determined value, the exposure level of the part is light and if the brightness value is less than the pre-determined value determining that the exposure level of the part is dark.

4. The method of claim 1 wherein determining the brightness value for the part comprises determining an average brightness value for an area comprising the part over which the pointing device is hovering.

5. The method of claim 1 wherein the pointing device is a finger.

6. The method of claim 1 further comprising, when adjusting the exposure level, temporarily providing an exposure adjustment indicator on the display and indicating the adjusted exposure level.

7. The method of claim 1 further comprising detecting a shaking of the device for a pre-determined period and resetting the adjusted exposure level to a default exposure level if the shaking of the device exceeds a pre-determined time period.

8. The method of claim 7, further comprising detecting that the shaking is in a pre-determined direction prior to resetting the adjusted exposure level to the default exposure level.

9. An apparatus comprising:
at least one processor, the at least one processor being configured to:
detect, on a touch screen device displaying an image, a pointing device in proximity to a part of the image;
determine an elapsed period of time associated with the proximity of the pointing device to the part, and if the elapsed period of time exceeds a pre-determined time period, activating an exposure control state of the device;
determine an exposure level of the part; and
adjust an exposure level of the image in a manner that is inverse to the determined exposure level of the part.

10. The apparatus of claim 9 wherein the pointing device is in a substantially fixed position.

11. The apparatus of claim 9 wherein the processor is configured to determine the exposure level of the part by:
determining a brightness value for the part;
determining if the brightness value of the part exceeds a pre-determined brightness value, wherein if the brightness value exceeds the pre-determined value, the exposure level of the part is light and if the brightness value is less than the pre-determined value determining that the exposure level of the part is dark.

12. The apparatus of claim 9 wherein the processor is configured to determine the brightness value for the part by determining an average brightness value for an area comprising the part over which the pointing device is hovering.

13. The apparatus of claim 9 wherein the pointing device is a finger.

14. The apparatus of claim 9 wherein the processor is further configured to adjust the exposure level and temporarily provide on the display an exposure adjustment indicator indicating the adjusted exposure level.

15. The apparatus of claim 9 wherein the apparatus further comprises a motion detecting device, the motion detecting device being configured to detecting a shaking of the device for a pre-determined period, and wherein the processor is further configured to reset the adjusted exposure level to a default exposure level if the shaking of the device exceeds a pre-determined time period.

16. The apparatus of claim 15 wherein the motion detector is further configured to detect that the shaking is in a pre-determined direction, and wherein the processor is further configured to reset the adjusted exposure level to the default exposure level if the shaking is in the pre-determined direction.

17. A computer program product comprising a computer-readable medium bearing computer code embodied therein for use with a computer, the computer program code comprising:
code for detecting, on a touch screen device displaying an image, a pointing device in proximity to a part of the image;
code for determining an elapsed period of time associated with the proximity of the pointing device to the part, and if the elapsed period of time exceeds a pre-determined time period, activating an exposure control state of the device;
code for determining an exposure level of the part; and
code for adjusting an exposure level of the image in a manner that is inverse to the determined exposure level of the part.

18. The computer program product of claim 17, the computer program code further comprising code for:
determining a brightness value for the part; and
determining if the brightness value of the part exceeds a pre-determined brightness value, wherein if the brightness value exceeds the pre-determined value, the exposure level of the part is light and if the brightness value is less than the pre-determined value determining that the exposure level of the part is dark.

19. The computer program product of claim 17, the computer program code further comprising code for determining an average brightness value for an area comprising the part over which the pointing device is hovering.

20. The computer program product of claim 17, the computer program code further comprising code for detecting a shaking of the device for a pre-determined period and resetting the adjusted exposure level to a default exposure level if the shaking of the device exceeds a pre-determined time period.
